(19) United States
(12) Patent Application Publication
(10) Pub. No.: US 2004/0031646 A1
(43) Pub. Date: Feb. 19, 2004

(54) FIRE ESCAPE LADDER

(75) Inventor: Francis Huang, Taipei (TW)

Correspondence Address: DORSEY & WHITNEY LLP, Four Embarcadero Center, Suite 3400, San Francisco, CA, 94111-4187, US

(73) Assignee: Likong Industrial Corp.

(21) Appl. No.: 10/223,890

(22) Filed: Aug. 19, 2002

(51) Int. Cl. E06C 1/52

(52) U.S. Cl. 182/198; 182/206

(57) ABSTRACT

A collapsible escape ladder is provided with a hook, two supporting straps, and a plurality of rungs which are connected in series by the two supporting straps passing through a first hole penetrating each rung. A standoff member is inserted through a second through hole in each rung which is communicated with the first through hole, and passes through an opening of each supporting strap which is aligned with the second through hole inside each rung, and a screw bole is screwed into the corresponding screw hole, thereby to fasten the plurality of rungs and the two supporting straps together.

### FIELD OF THE INVENTION

The present invention relates to a fire escape ladder and more particularly to a collapsible escape ladder which is easy and fast to be deployed from a building for allowing a person to escape in case of emergency such as a fire.

### BACKGROUND OF THE INVENTION

In general, the escape ladder is used to be deployed from a window of a building to facilitate persons to escape from the building in case of a fire. Therefore, the escape ladder is required to be lightweight, compact and easy to be stored, and readily and safely deployed.

U.S. Pat. No. 5,499,692 discloses an escape ladder of collapsible construction in which a plurality of rungs may be collapsed if it is to be stored. In the construction, a pair of side links are inserted into a slot provided in each side of a rung, the other end of one of the side links is inserted into a slot in one end of one adjacent rung so as to connect these two rungs in a pivotal manner while the other end of the other side link of is inserted into a slot of another adjacent rung so as to connect these two rungs in a pivotal manner. In this manner, a plurality of rungs can be connected in series. In a collapsible state, the plurality of rungs can be stacked together. In a deployed state, the escape ladder can be vertically deployed downward due to the weight of rungs. Although this construction is collapsible, it is still bulky and it can not be rapidly deployed downward due to the pivotal construction.

U.S. Pat. No. 6,279,681 discloses a collapsible ladder in which a plurality of rungs is connected by a webbing support. In this construction, the plurality of rungs are connected in series in such a manner that the webbing support is passed through two slits provided close to each edge of each rung.

### SUMMARY OF THE INVENTION

An object of this invention is to provide an escape ladder which is compact in a collapsible state, and can safely and rapidly descend to allow the user to escape fast and freely in a deployed state.

According to one aspect of the present invention, a collapsible escape ladder, comprises a hook being collapsible and being provided with two foldable supporting arms and a foldable link connected between the two supporting arms; a plurality of rungs, each of which is formed with a pair of first through holes which penetrate the rung at places near ends of top and bottom sides of the rung and are substantially parallel to each other and a pair of second through holes which penetrate the rung at places near ends of lateral sides of the rung and are substantially parallel to each other and are communicated with the first through holes in an substantially orthogonal manner; two supporting straps formed with openings which are spaced from each other with a predetermined interval, one end of each supporting strap being attached to the hook and the other end passing through the first through hole in each rung in such a manner that each opening is aligned with the corresponding second through hole inside the rung; a plurality of standoff members, each of which is provided with a protection cap on one end thereof and a screw hole at the other end; and wherein each of the standoff members is inserted through the second through hole in each rung and passes through the opening in the supporting strap, and a screw bole is screwed into the corresponding screw hole, thereby to fasten the plurality of rungs and the two straps together.

According to another aspect of the present invention, a fastening strap with a magic tape is attached to the bottom rung for fixing the escape ladder in the collapsible state. The magic tape is used to fasten the fastening strap if the escape ladder is to be collapsed, and can be easily detached to allow the escape ladder descend rapidly upon being deployed.

### BRIEF DESCRIPTION OF DRAWINGS

The above and other objects, features and advantages of the present invention will be more apparent from the following explanation with reference to drawings, wherein

FIG. 1(a) and 1(b) are a side view and a perspective view of an escape ladder according to the present invention being deployed along a wall, respectively;

FIG. 2 is a perspective view of the escape ladder according to the present invention in a collapsible state; and

FIG. 3(a) and 3(b) are side view and cross sectional view showing the joint of a rung, a supporting strap and a stand-off pole according to this invention, respectively.

### DETAILED DESCRIPTION OF THE PREFERRED EMBODIMENT

The preferred embodiment according to the present invention will be explained below with reference to drawings.

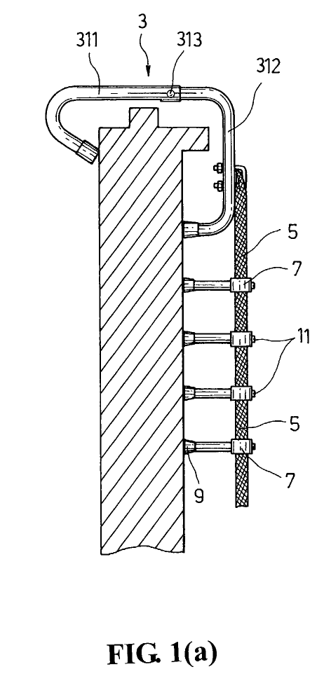

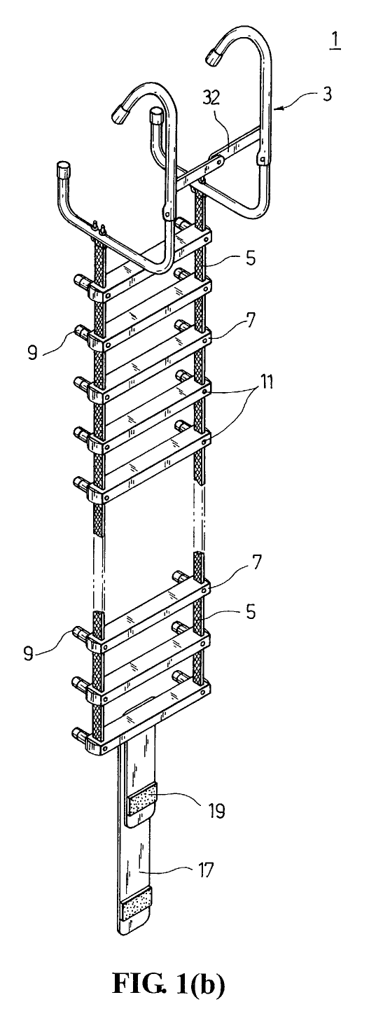

FIG. 1(a) is a side view showing that the escape ladder 1 according to the embodiment of the present invention is vertically and downward deployed along a wall from a window sill or an edge of a wall. As shown in FIG. 1(a), in the deployed state, the escape ladder 1 is fixed to the window sill by a hook 3 and automatically descends along the wall due to the weight of a plurality of rungs 7.

As seen in FIG. 1(b), the escape ladder 1 is provided with a hook 3 for fixing to the sill. Two supporting straps 5 are attached beneath the hook 3 for connecting the plurality of rungs 7 which are spaced from each other with a predetermined interval. Each of the plurality of rungs 7 has two standing-off poles 9 on ends of its side facing the wall so as to keep the rungs away from the wall by a predetermined distance and thus a user can step down quickly along the escape ladder without being hindered. One end of the stand-off pole 9 contacting the wall is covered with a protection cap made of rubber so as to stabilize the escape ladder by means of the strong friction force between the wall and the cap if the escape ladder 1 is in use. In addition, a fastening strap 17 provided with a magic tape 19 is attached to the last one of the plurality of rungs 7 (hereafter called as “bottom rung”) for fastening the escape ladder 3 in the collapsible state. The connection between the supporting straps 5 and the plurality of rungs 7 will be explained below.

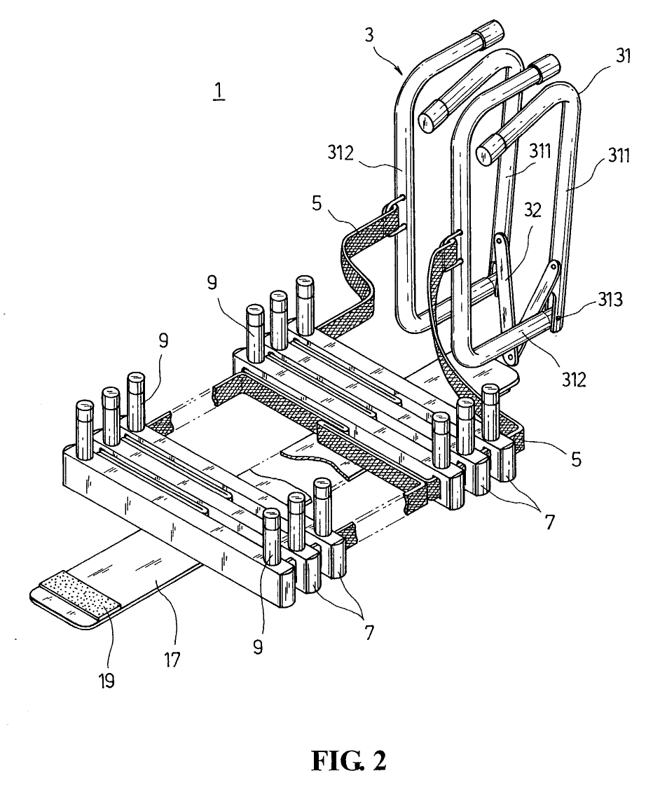

FIG. 2 is a perspective view showing the escape ladder 1 of the present invention in the collapsible state. As shown in FIG. 2, the hook 3 consists of two separate arms 31 and a foldable link 32 connected between the two arms 31. Each arm 31 has an upper portion 311, a lower portion 312 and pivotal means 313. The arm 31 is foldable due to the provision of the pivotal means 313 jointing the upper portion 311 and the lower portion 312. The hook 3 can be collapsed in such a manner that the two arms 31 are collapsed by folding the upper portion 311 and lower portion 312 and the link 32, as shown in FIG. 2, if the escape ladder is to be stored. The Supporting strap 5 is attached to the hook 3 via a ring 33 provided beneath the hook 3. For example, the supporting strap is formed by sewing at least two fabric straps made of nylon. In the collapsed state, the hook 3 may be folded, the plurality of rungs 7 connected by two supporting straps 5 may be easily stacked one by one, and then the collapsible hook 3 and the stacked rungs 3 are tied together by the fastening strap 17 attached to the bottom rung 7, and finally the fastening strap 17 is fastened by the magic tape 19. Therefore, the escape ladder of this invention is easy to be stored in a compact manner without occupying two much space, and is easy and fast to be deployed.

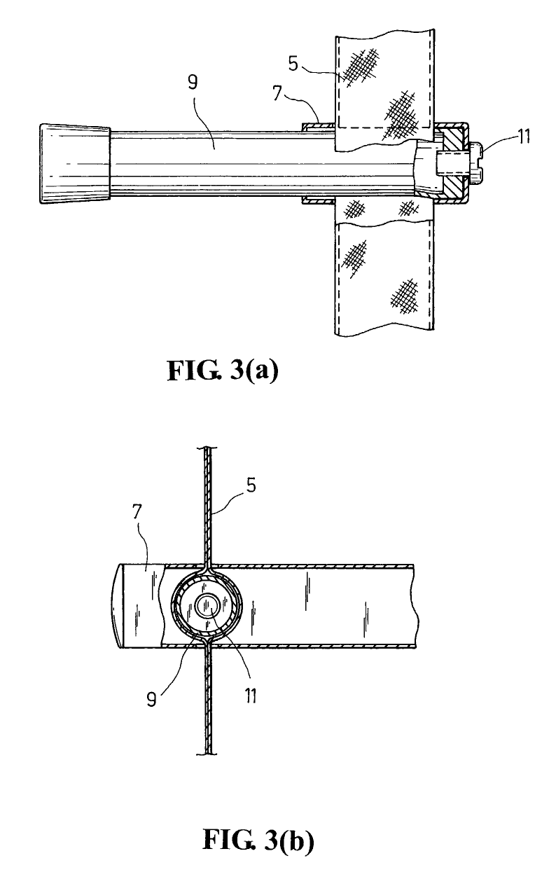

The connection between the supporting straps 5 and the plurality of rungs is explained hereafter. FIG. 3(a) and 3(b) are side view and cross sectional view, respectively, showing the connection between the support strap 5 and the rung 7 of the escape ladder 1 according to the present invention. The supporting strap 5 is formed in such a manner that two fabric straps made of nylon are sewed together but some predetermined portions of these two straps are not sewed together, thereby to from a plurality of openings spaced from each other with a predetermined interval. In other words, one opening is formed by the unsewed portions of the two straps every predetermined interval. The size of the opening is adapted to allow the stand-off pole 9 to pass through. A pair of first through holes penetrating through top and bottom of each rung 7 are formed at places near two ends of the rung 7, respectively and they are substantially parallel with each other. A pair of second through holes penetrating through sides of each rung 7 facing the wall are formed to be substantially orthogonal to the first holes, respectively. In connecting the rungs, the supporting strap 5 passes through the first hole in each rung 7 with the opening aligned with the second hole, and then the supporting pole 9 is inserted into the second through holes and passes through the opening of the supporting strap 5, and a screw bolt 11 is screwed into one end of the supporting pole 9 which is opposite to the end having a cap and is formed with threaded hole for receiving the screw bolt, from the other side of the second hole, thereby to fasten the rung 7 and the supporting strap 5 together. In this manner, the supporting straps 5 connect the plurality of rungs 7 in series so as to form the escape ladder 1.

While the invention has been described in conjunction with the detailed description of the embodiment, various variations and modifications can be made without departing from the spirit or the scope of this invention defined by the appended claims.

1. A collapsible escape ladder comprising:
a hook being collapsible and being provided with two foldable supporting arms and a foldable link connected between the two supporting arms;
a plurality of rungs, each of which is formed with a pair of first through holes which penetrate the rung at places near ends of top and bottom sides of the rung and are substantially parallel to each other and a pair of second through holes which penetrate the rung at places near ends of lateral sides of the rung and are substantially parallel to each other and are communicated with the first through holes in an substantially orthogonal manner;
two supporting straps formed with openings which are spaced from each other with a predetermined interval, one end of each supporting strap being attached to the hook and the other end passing through the first through hole in each rung in such a manner that each opening is aligned with the corresponding second through hole inside the rung;
a plurality of standoff members, each of which is provided with a protection cap on one end thereof and a screw hole at the other end; and
wherein each of the standoff members is inserted through the second through hole in each rung and passes through the opening in the supporting strap, and a screw bole is screwed into the corresponding screw hole, thereby to fasten the plurality of rungs and the two straps together.

2. A collapsible escape ladder according to claim 1, wherein each of the supporting straps is formed by sewing more than two fabric straps made of nylon.

3. A collapsible escape ladder according to claim 1, wherein each end of the two supporting arms of the hook is covered with a cap made of rubber.

4. A collapsible escape ladder according to claim 1, wherein the cap covering one end of each standoff member is made of rubber.

5. A collapsible escape ladder according to any one of claims 1 to 4, further including a fastening strap provided with a magic tape on ends thereof and attached to one of the rungs which is farthest away from the hook.
